(19) United States
(12) Patent Application Publication
(10) Pub. No.: US 2013/0010030 A1
(43) Pub. Date: Jan. 10, 2013

(54) BENDING MEMBER, RAIL MEMBER, AND IMAGE-FORMING APPARATUS

(75) Inventor: Shumpei TAKAHASHI, Chigasaki-shi (JP)

(73) Assignee: RICOH COMPANY, LTD., Tokyo (JP)

(21) Appl. No.: 13/539,645

(22) Filed: Jul. 2, 2012

(30) Foreign Application Priority Data
Jul. 6, 2011 (JP) 2011-149851
Jan. 18, 2012 (JP) 2012-008339

(51) Int. Cl. B41J 23/14; B31F 1/00

(52) U.S. Cl. 347/37; 493/395

(57) ABSTRACT

A bending member includes a bent portion formed by bending a plate material, the bent portion including a concave surface side and a convex surface side, a curvature radius r of the concave surface side of the bent portion being set to a thickness t of the plate material or below, and a plurality of grooves provided in the bent portion on the convex surface side, each of the grooves being vertical to a longitudinal direction of the bent portion, wherein each of the grooves opens on both surface sides sandwiching the bent portion, and each of the grooves includes a bottom portion having a straight line shape connecting the openings of the groove on the both surface sides.

### PRIORITY CLAIM

The present application is based on and claims priority from Japanese Patent Application No. 2011-149851, filed on Jul. 6, 2011 and Japanese Patent Application No. 2012-008339, filed on Jan. 18, 2012, the disclosures of which are hereby incorporated by reference in their entirety.

### BACKGROUND

1. Field of the Invention

The present invention relates to a bending member in which a plate material is bent, a rail member and an image-forming apparatus using the bending member.

2. Description of the Related Art

In a bending member in which a plate material is bent, an outside material of a bent portion stretches and an inside material of a bent portion shrinks. The outside material of the bent portion is pulled along the bent portion so as to cover the stretched portion. Owing to such strength and shrinkage, so-called saddle warpage occurs in which the bending member warps along the bent portion. Therefore, it is known that saddle warpage of the bending member can be reduced by providing a plurality of concave portions on the convex surface side of the bent portion at intervals in the longitudinal direction of the bending member in the final step of a bending process using a die (refer to Japanese Patent Publication No. 3633012).

By providing the concave portions on the convex surface side of the bent portion of the bending member, the materials in the concave portions are moved in the longitudinal direction of the bent portion to be supplied to the portions between the concave portions, so that the tension of the outside of the bent portion is reduced; thus, the saddle warpage can be reduced.

The above effect can be obtained by the concave portions in the longitudinal direction of the bent portion, but the materials are pushed in the directions of both surfaces sandwiching the bent portion, resulting in the loss of the flatness of both surfaces sandwiching the bent portion. In particular, the area of the bent portion is small and both surfaces which require flatness are disposed close to the bent portion when a bending member is formed with a curvature radius smaller than a thickness of the bending member. For this reason, it is difficult to maintain the flatness of the two surfaces sandwiching the bent portion if the concave portions are provided in the bent portion.

An ink-jet type image-forming apparatus which records an image by discharging liquid ink drops on a recording sheet with a recording head of an ink discharger provided in a carriage which moves on a guide rail of a rail member (refer to, for example, Japanese Patent Application Publication No. H09-99603) is known. The ink-jet type image-forming apparatus is required to have improved landing accuracy of ink drops relative to a recording sheet in order to achieve a high quality image because the ink drops discharged from a recording head directly land on a recording sheet to form an image.

However, if the flatness accuracy of the guide surface of the bending member is deteriorated when using the above-described bending member as a guide rail, the ink drops can not be discharged in a desired position of a sheet from the recording head while forming an image by moving the carriage on the guide rail, resulting in the deterioration in an image quality.

### SUMMARY

The present invention has been made in view of the above circumstances, and an object of the present invention is to provide a bending member capable of obtaining highly accurate flatness on both surfaces sandwiching a bent portion of the bending member, a rail member and an image-forming apparatus using the bending member.

In order to achieve the above object, one embodiment of the present invention provides a bending member including a bent portion formed by bending a plate material, the bent portion including a concave surface side and a convex surface side, a curvature radius r of the concave surface side of the bent portion being set to a thickness t of the plate material or below, and a plurality of grooves provided in the bent portion on the convex surface side, each of the grooves being vertical to a longitudinal direction of the bent portion, wherein each of the grooves opens on both surface sides sandwiching the bent portion, each of the grooves includes a bottom portion having a straight line shape connecting the openings of the groove on the both surface sides, a length L of the bottom portion having the straight line shape is larger than twice the curvature radius r, and a depth d of the deepest portion of each groove is smaller than the thickness t of the plate material.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 is a view describing an opening width of a groove.

FIG. 2 is a perceptive view illustrating one example of an image-forming apparatus as seen from the front side.

FIG. 3 is a plan view illustrating a main portion of a mechanical section of the image-forming apparatus.

FIGS. 4A, 4B, 4C are views each illustrating non-uniform deformation of a material of a bent portion.

FIG. 5A is a front view illustrating a bent portion according to Constitution Example 1.

FIG. 5B is a sectional view illustrating the bent portion according to Constitution Example 1.

FIG. 6 is a detailed sectional view illustrating the bent portion according to Constitution Example 1.

FIG. 7A is a front view illustrating a bent portion according to Constitution Example 2.

FIG. 7B is a sectional view illustrating the bent portion according to Constitution Example 2.

FIG. 8 is a detailed sectional view illustrating the bent portion according to Constitution Example 2.

FIGS. 9A, 9B are views each illustrating a die for use in a bending process of a plate material.

FIG. 10 is a functional system chart.

FIG. 11 is a view illustrating positions in a bending member where output flatness accuracy is measured.

FIG. 12 provides a graph illustrating a relationship between the amount of warpage and a depth of a groove under a certain condition performed in an experiment.

FIG. 13A provides a factor effect graph illustrating a relationship between a depth of a groove and an SN ratio obtained by an experiment using quality engineering.

FIG. 13B provides a factor effect graph illustrating a relationship between a depth of a groove and a sensitivity obtained by an experiment using quality engineering.

FIG. 14 provides a view illustrating a relationship between an opening width of a groove and the amount of warpage.

FIG. 15A provides a graph illustrating flatness accuracy (flatness) when a groove under the most suitable condition obtained by quality engineering is provided.

FIG. 15B provides a graph illustrating flatness accuracy (flatness) when a groove is not provided.

FIGS. 16A, 16B, 16C, 16D are views each describing warpage correction according to an embodiment of the present invention.

FIG. 17A is a front view describing intervals between grooves according to the embodiment of the present invention.

FIG. 17B is a side view describing the interval between the grooves according to the embodiment of the present invention.

FIG. 18 provides a graph illustrating a relationship between the amount of warpage and an interval between grooves under a certain condition performed in an experiment.

FIG. 19A provides a factor effect graph illustrating a relationship between an interval between grooves and an SN ratio obtained by an experiment using quality engineering.

FIG. 19B provides a factor effect graph illustrating a relationship between an interval between grooves and a sensitivity obtained by an experiment using quality engineering.

FIG. 20A is a front view illustrating a bending member in which intervals between grooves are provided at equal intervals.

FIG. 20B is a side view illustrating the bending member in which the intervals between the grooves are formed at equal intervals.

FIG. 21A is a front view illustrating a bending member in which intervals between grooves are provided at equal intervals in the central portion of a bent portion in the longitudinal direction and intervals between grooves in the end portions of the bent portion in the longitudinal direction differ from those in the central portion.

FIG. 21B is a side view illustrating the bending member in which the intervals between the grooves are provided at equal intervals in the central portion of the bent portion in the longitudinal direction and the intervals between the grooves in the end portions of the bent portion in the longitudinal direction differ from those in the central portion.

FIG. 22 is a view describing the supply of a material by a groove.

FIG. 23A is a front view illustrating a guide rail.

FIG. 23B is a sectional view illustrating the guide rail.

FIG. 23C is a perspective view illustrating a state in which a carriage is held in the guide rail.

FIG. 24A provides a graph illustrating flatness accuracy (flatness) of a guide rail having a groove.

FIG. 24B provides a graph illustrating flatness accuracy (flatness) of a guide rail without having a groove.

FIG. 25 provides a graph illustrating a difference in straight-traveling performance of a carriage in the main-scanning direction when using a guide rail having a groove and a guide rail without having a groove.

FIG. 26 is a view describing a conventional technique.

### DESCRIPTION OF THE PREFERRED EMBODIMENT

Hereinafter, an embodiment of an image-forming apparatus will be described with reference to the drawings. FIG. 2 is a perspective view illustrating the image-forming apparatus according to the embodiment of the present invention as seen from the front side.

The image-forming apparatus includes a main body 1, a paper feeding tray 2 on which sheets provided in the main body 1 are placed, and a paper discharge tray 3 which is detachably attached to the main body 1 and on which a sheet as a recording material formed with an image is stocked. The image-forming apparatus also includes on one end side (paper discharge tray side) of the front face of the main body 1 a cartridge-loading section 4 in which an ink cartridge is loaded. The cartridge-loading section 4 projects on the front side of the main body 1 from the front face of the main body 1, and is provided to be lower than the top surface of the main body 1. The cartridge-loading section 4 includes on the top surface thereof an operation and display portion 5 in which an operation button, a display or the like is provided.

A plurality of ink cartridges 10k, 10c, 10m, 10y (they are simply referred to as an ink cartridge 10 when colors are not distinguished) of recording liquid cartridges containing, for example, black (K) ink, cyan (C) ink, magenta (M) ink and yellow (Y) ink, respectively, can be inserted in the cartridge-loading section 4 from the front face side of the main body 1. The front face side of the cartridge-loading section 4 includes an openable and closeable front cover (cartridge cover) 6 which opens when removing the ink cartridge 10. The ink cartridges 10k, 10c, 10m, 10y are laterally loaded with a longitudinally placed state.

The front cover 6 is made of a transparent or translucent member so that a plurality of ink cartridges 10k, 10c, 10m, 10y loaded in the cartridge-loading section 4 can be seen from the outside with the front cover closed. In addition, a part of the ink cartridges 10k, 10c, 10m, 10y can be made of a transparent or translucent member as long as the ink cartridges 10k, 10c, 10m, 10y can be seen from the outside.

The operation and display portion 5 includes in positions corresponding to the loaded positions of the ink cartridges 10k, 10c, 10m, 10y remaining amount display portions 11k, 11c, 11m, 11y of respective colors (they are simply referred to as a remaining amount display portion 11 when colors are not distinguished) which display that the remaining amount of the ink cartridges 10k, 10c, 10m, 10y of respective colors is nearly zero or zero. The operation and display portion 5 also includes a power source button 12, paper-feeding/printing restart button 13 and cancel button 14.

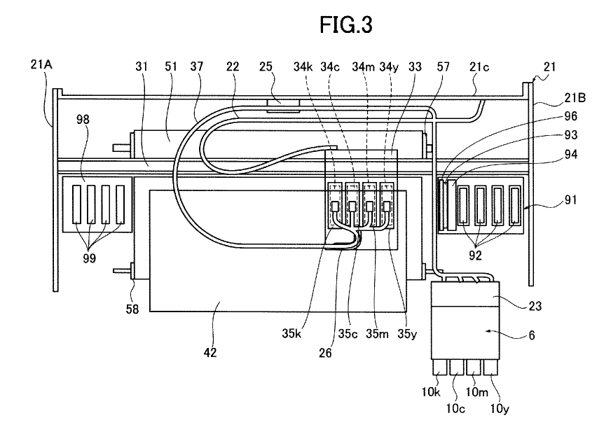

Next, the mechanical section of the image-forming apparatus will be described. FIG. 3 is a plan view illustrating the main portion of the mechanical section of the image-forming apparatus.

A carriage 33 is held to be slidable in the main-scanning direction along a guide rail 33 of a guide member which is bridged laterally to right and left side plates 21A, 21B constituting a frame 21. The carriage 33 moves and scans in the arrow direction (carriage scanning direction: main-scanning direction) in FIG. 3 by a not shown main-scanning motor, This carriage 33 includes a plurality of recording heads 34 as liquid discharge heads which discharge liquid drops (ink drops) of recording liquid. A plurality of nozzles of the recording heads 34 is arranged in the direction which intersects the main-scanning direction.

The recording heads 34 includes, for example, a recording head 34y which discharges yellow (Y) liquid drops, a recording head 34m which discharges magenta (M) liquid drops, a recording head 34c which discharges cyan (C) liquid drops and a recording head 34k which discharges black (K) liquid drops. In addition, they are simply referred to as a recording head 34 when colors are not distinguished. The recording heads 34y, 34m , 34c except black can be referred to as color recording heads. The head constitutions are not limited to these examples. One or more recording heads including one or more nozzles which discharge one or more color liquid drops can be used.

As the recording head 34, a recording head including, for example, a piezo actuator such as a piezo element, a thermal actuator using phase-change due to film boiling of liquid by using an electrothermal conversion element such as a heat resistor, a shape-memory-alloy actuator using metallic phase change due to temperature change, and an electrostatic actuator using an electrostatic force as a discharge driver for discharging liquid drops is used.

The carriage 33 includes head tanks 35y, 35m, 35c, 35k of respective colors (they are simply referred to as a head tank 35 when colors are not distinguished), which supply recording liquid of respective colors to the recording heads 34, respectively. The recording liquid is supplied to the head tanks 35 from the above-described ink cartridges 10 of respective colors (they are referred to as the ink cartridges 10y, 10m, 10c, 10k when colors are distinguished) through recording liquid supply tubes 37 of respective colors.

In the present invention, “sheet” is not limited to paper. It includes, for example, OHP, fiber, glass and substrate, that is, a material on which ink drops or another liquid can be adhered, and also includes, for example, a medium to be recorded, a recording medium, recording paper and a recording sheet. Moreover, “image formation”, “recording”, “printing” and “copying” are equivalent terms.

In addition, “image-forming apparatus” means an apparatus which forms an image by discharging liquid on a medium such as a sheet, string, fiber, fabric, leather, metal, plastic, glass, wood or ceramics. “Image formation” means not only to apply an image having characters, shapes or the like to a medium but also to apply an image without having a pattern to a medium (liquid drops are simply landed on a medium).

“Ink” is not especially limited. It includes all kind of liquid which can be used for forming an image, for example, recording liquid or fusing process liquid. It also includes a DNA sample, resist pattern material or resin.

“Image” is not limited to a plan image. It includes an image applied to a 3D structure or a 3D image.

Next, the operation of the image-forming apparatus in the present embodiment will be described.

In the image-forming apparatus of the present embodiment, one separated sheet is fed from the paper-feeding tray 2, and the sheet is fed to pass through a printing area facing the recording heads 34y, 34m, 34c, 34k. The ink drops of respective colors are discharged from the recording heads 34y, 34m, 34c, 34k while the sheet passes through the printing area, and an image is thereby formed on the sheet. When recording an image by the recording heads 34y, 34m , 34c, 34k, the feeding of the sheet is once stopped, the recording heads 34y, 34m, 34c, 34k are driven according to image signals corresponding to a printing order while moving the carriage 33 in the main-scanning direction, the ink drops are discharged on the stopped sheet, and an image for one line (one scanning) is recorded. After that, the sheet is fed in the sub-scanning direction by a predetermined amount, and then the sheet is once stopped again. After that, the recording of the next line is performed. The image-forming operation is completed by receiving a recording complete signal or a signal which informs that the back end of the sheet reaches a predetermined position in the sub-scanning direction, and the sheet is discharged on the discharge tray 3.

A maintenance unit 91 which maintains and recovers the condition of the nozzle of the recording head 34 is provided in a non-printing area of one side of the scanning direction of the carriage 33. The maintenance unit 91 includes cap members 92 as enclosed space-forming members which cap respective nozzle faces of the recording heads 34, a wiper blade 93 which wipes the nozzle face, and an unused discharge receiver 94 which receives liquid drops discharged in unused discharging (discharging of liquid drops which do not contribute to image recording). A sub-maintenance unit 98 including an unused discharge receiver 99 which receives liquid drops in unused discharging is also provided in a non-printing area of the other side of the scanning direction of the carriage 33.

When performing an ink suction process at a predetermined ink suction timing, at first, the carriage 33 is moved to the maintenance unit 91, and the nozzle surface of the recording head 34 which is directed just below in the vertical direction is capped by the cap member 92 from the lower side. In this way, the inside of the cap member 92 which covers the nozzle face is sealed. Upon sucking the inside of the cap member 92 with a not illustrated suction pump connected to a suction port provided in the cap member 92, the cap member 92 is absorbed to the nozzle surface of the recording head 34, the sealing performance inside the cap member is improved, and the inside of the cap member becomes a negative pressure, so that the ink inside the recording head 34 is sucked from the nozzle 34a on the nozzle surface.

When performing an unused discharge process at a predetermined unused discharge timing, the carriage 33 is moved to the maintenance unit 91 or the sub-maintenance unit 98, and the nozzle surface of the recording head 34 which is directed just below in the vertical direction faces the unused discharge receivers 94, 99. Then, the ink drops are discharged from the nozzle 34a of the recording head 34 by predetermined unused discharge driving.

The ink drops can not be discharged in a predetermined position of a sheet from the recording head 34 while forming an image by moving the carriage 33 if the flatness accuracy of the guide rail 31 is deteriorated, so that the quality of an image is deteriorated.

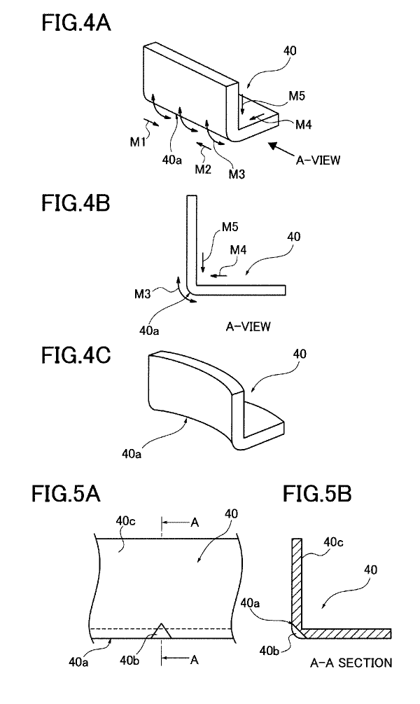

FIGS. 4A-4C are views each describing non-uniform deformation of a material of a bent portion.

In a bending member 40 in which a plate material is bent, the outside material of a bent portion 40a stretches in the arrow M3 direction and the inside material of the bent portion 40a shrinks in the arrow M4 direction and the arrow M5 direction. The outside material of the bent portion 40a is pulled from the end portions to the central portion in the longitudinal direction in the arrow M1 direction and the arrow M2 direction so as to cover the stretched material. Owing to such non-uniform stretch and shrinkage, warpage occurs in the bent portion 40a.

As a method of reducing such warpage, a constitution which forms a concave portion in the bent portion has been adopted as illustrated in FIG. 26. The warpage of the bent portion in the longitudinal direction can be reduced by forming such a concave portion, but the material pushed by the concave portion is swelled in the direction vertical to the longitudinal direction as the two circled portions in FIG. 26, so that the flatness of both surfaces sandwiching the bent portion is lost. The swelling due to the concave portion does not occur outside the range of the bent portion having a curvature if the bent portion has a gentle curvature as illustrated in FIG. 26, so that the flatness of both surfaces sandwiching the bent portion is not affected. However, such a constitution does not contribute to the downsizing of the bending member.

On the other hand, the bending member can be downsized if a curvature radius is decreased. However, the flat surfaces of both sides sandwiching the bent portion are located very close to the concave portion if a concave portion which can reduce the warpage is formed. For this reason, it becomes difficult to maintain the flatness of these surfaces with a high accuracy as described above.

### CONSTITUTION EXAMPLE 1

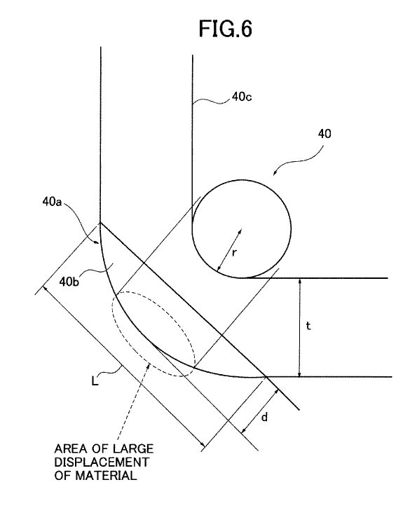

FIG. 5A is a front view illustrating a bent portion 40a of a bending member 40 according to Constitution Example 1 of the present invention. FIG. 5B is a sectional view illustrating the bent portion 40a of the bending member 40 according to Constitution Example 1 of the present invention. FIG. 6 is a view illustrating the bent portion in FIG. 5B in detail.

As illustrated in FIGS. 5A, 5B, a groove 40b which is vertical to the longitudinal direction of the bent portion is provided on the convex surface side along the bent portion 40a of a bent surface 40c of the bending member 40. As just described, the groove 40b is provided in the bent portion 40a, so that the material of the bending member 40 protrudes on both sides of the groove 40b. Therefore, the warpage of the bent portion 40a can be reduced. Moreover, the protrusion of the material of the bending member 40 to both end portions of the groove in the longitudinal direction can be reduced because a groove shape is used. For this reason, the flatness of both surfaces (the vertical and horizontal surfaces of the L-shape structure in FIG. 5B) sandwiching the bent portion can be maintained with a high accuracy.

The details will be described hereinbelow with reference to FIG. 6. In the present example, a compact bending constitution in which a curvature radius r of the bent portion 40a on the concave surface side is a thickness t of the plate material or less is used. With this constitution, the curved surface portion is downsized, so that if the concave portion is formed in the curved surface portion, the flatness of both surfaces (the vertical and horizontal surfaces of the L-shape constitution in FIG. 5B) sandwiching the bent portion can not be maintained with a high accuracy due to the materials protruded by the concave portion.

Consequently, in the present example, a plurality of grooves which is vertical to the longitudinal direction of the bent portion 40a is formed in the bent portion 40b on the convex surface side. Both ends of the groove open on the sides of both surfaces (the vertical and horizontal surfaces of the L-shape structure in FIG. 5B) sandwiching the bent portion, and the bottom portion of the groove is formed in a straight line shape connecting the opening portions on the sides of both surfaces. With this constitution, the depth of the groove is gradually reduced as it approaches the opening portions, so the amount of material which is pushed near the opening portions is reduced. Therefore, the flatness of both surfaces (the vertical and horizontal surfaces of the L-shape structure in FIG. 5B) can be maintained with a high accuracy.

The length L of the linear bottom portion of the groove is larger than twice the curvature radius r, and the depth d of the deepest portion of the groove is smaller than the thickness t of the plate material. The area where the material is moved by the bending is increased if the curvature radius of the bending is increased, and the area is decreased if the curvature radius is decreased. The material is largely moved in the area twice the curvature radius r (curvature diameter) at least on the concave surface side regardless of the thickness of the plate material. For this reason, it is necessary for the length L of the linear bottom portion of the groove to be a length twice the curvature radius r or more.

On the other hand, if the depth d is larger than the thickness t, the groove penetrates through the plate material, so that not only the material on the concave surface side but also the material on the convex surface side are pushed in the right and left of the groove; thus, the effect of the correcting the warpage can not be obtained. More specifically, it is necessary to set the depth d smaller than the thickness t in order to correct the warpage by pushing only the material of the bent portion 40a on the convex surface side in the longitudinal direction of the bending member.

In addition, the length L of the linear bottom portion of the groove is not specifically limited. The effect can be obtained as long as the bottom portion of the groove has a straight line shape and the depth d is smaller than the thickness t. However, it is preferable for the length L to be 2×(r+t) in which the thickness of both surfaces is added to twice the curvature radius or less in terms of the strength maintenance of the groove formed portion.

The sectional shape of the groove as seen from the longitudinal direction is illustrated in V-shape in FIG. 5A. However, the sectional shape is not limited thereto. The effect of the present invention can be obtained even if it has a rectangle, trapezoid or W-shape, for example as long as the material of the groove can be pushed on the right and left of the groove.

### CONSTITUTION EXAMPLE 2

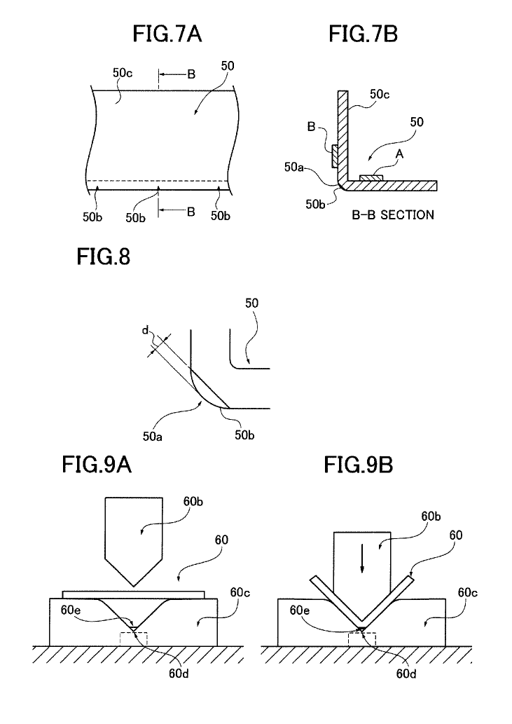

FIG. 7A is a front view illustrating a bending member 50 according to Constitution Example 2 of the present invention. FIG. 7B is a sectional view illustrating the bending member 50 according to Constitution Example 2 of the present invention. FIG. 8 is a view illustrating the bent portion in FIG. 7B in detail.

In this Constitution Example, the shape of a groove 50b provided along a bent portion 50a of a bent surface 50c differs from the shape of the groove provided along the bent portion of the bending member according to Constitution Example 1 illustrated in FIG. 6. With the shape of the groove provided in the bent portion in Constitution Example 1, the highly accurate flatness of both surfaces can be obtained, and the warpage amount in the longitudinal direction of the bent portion can be reduced by controlling the pushing of the material to both surfaces sandwiching the bent portion. However, it is necessary to consider the arrangement and the figure of the groove in order to further control the warpage amount. In this example, a groove which reduces the warpage in the longitudinal direction of the bent portion is obtained by an experiment using quality engineering.

FIG. 9 is a view describing a die structure for bending a plate material and forming the groove 50b in the bent portion.

As illustrated in FIG. 9A, after placing a plate material 60 of a material to be processed on an upper surface of a die 60c, the bending process is applied to the plate material by pushing the plate material 60 with a punch 60b as illustrated in FIG. 6B. In this case, if the plate material 60 hits the bottom surface of the die 60c, the bent portion of the plate material 60 hits a projection 60e of an insert 60d projecting from the bottom surface of the die 60c, so that the groove 50b is formed in the bent portion of the plate material 60.

<Experiment using Quality Engineering>

How much the processing conditions such as a processing force, a depth of a groove, an interval between grooves or the like affect the warpage amount was investigated, in order to reduce the warpage amount. The warpage amount of a bent component is determined according to many factors such as a processing condition, die specification, material or equipment specification. It takes a long time to find the best condition among these factors.

The factors which can reduce the warpage amount were studied by using the quality engineering. After performing an experiment using the quality engineering, it was found that highly accurate flatness can be obtained by increasing the intervals between the grooves and by reducing the depth of the groove.

The outline of the experiment plan will be described hereinbelow. Considering an ideal warpage free condition, a zero-nominal-the-best characteristic was used.

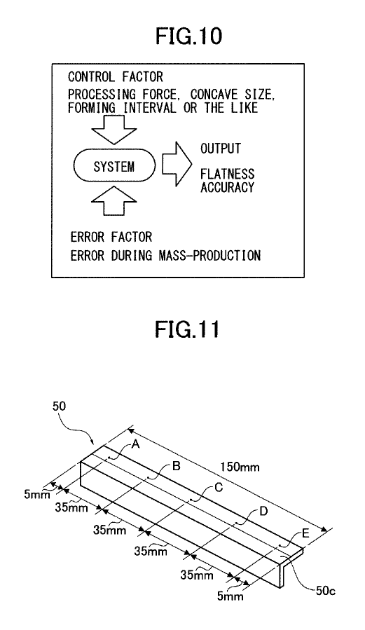

FIG. 10 is a functional system view. The experiment was performed by using the factors illustrated in the system view. FIG. 11 illustrates measurement positions of the bending member 50 of a test piece where the output flatness accuracy was measured. The warpage amount of the surface 50c of the bending member 50 was measured in five measurement points A, B, C, D, and E. The warpage amount of the surface 50c of the bending member 50 was measured. The SN ratio was calculated by using the following Formula 1 from the measurement result and the sensitivity was calculated by using the following Formula 2.

$$SN ratio η = - 101 og \frac{1}{{σ}^{2}} \qquad [ Formula 1 ]$$

σ=standard deviation of output

Formula 2]

Sensitivity S=m

m: average value of output

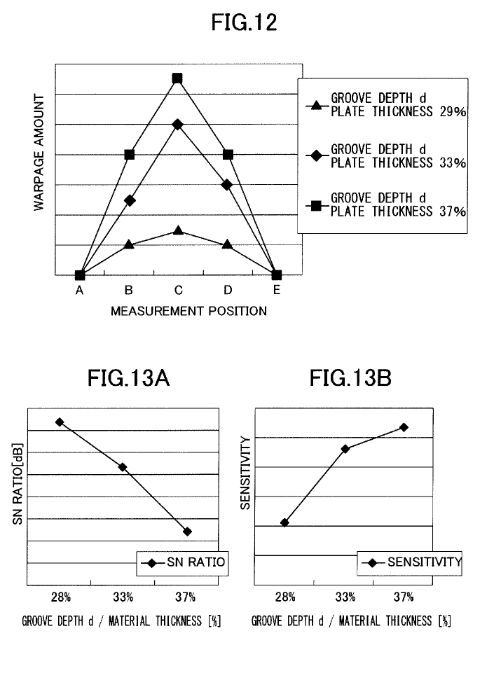

FIG. 12 provides a graph illustrating a relationship between the warpage amount and the depth d of the groove 50b under a predetermined condition performed in the experiment. In this case, the thickness t is 0.8 mm, the value of the curvature radius r is 0.1 mm, 15 grooves are provided to be symmetric in the bending member, the interval between grooves is 10 mm and the length L1 of the member is 150 mm. In addition, the depth d of the groove 50b is illustrated by a ratio relative to a thickness, and the depth d of the groove 50b is decreased according to the decrease in the value. In this case, it is illustrated when the depth d of the groove 50b is 29% of the thickness, 33% of the thickness and 37% of the thickness. FIG. 12 shows an effect in which the warpage amount in each measurement position is reduced if the depth d of the groove 50b is reduced.

FIG. 13A provides a factor effect graph illustrating a relationship between the depth d of the groove 50b and the SN ratio obtained by the experiment using the quality engineering. FIG. 13B provides a factor effect graph illustrating a relationship between the depth d of the groove 50b and the sensitivity obtained by the experiment using the quality engineering.

As is seen from FIG. 13A, the SN ratio is increased if the depth d of the groove 50b is reduced. Namely, the variation is reduced. As is also seen from FIG. 13B, the sensitivity is decreased if the depth d of the groove 50b is reduced. For this reason, it was found that a bending member having good flatness accuracy can be manufactured by using a reduced depth d of the groove 50b. The recall ratio with this experiment (the ratio of the SN ratio estimated from the experiment and the SN ratio obtained by a confirmation experiment) was 82%. For this reason, the factor effect graphs illustrated in FIGS. 13A, 13B based on the experiment results using the quality engineering are reliable.

The decrease in the warpage amount by reducing the depth d of the groove 50b has the following factor. The groove 50b has an effect of supplying a material to the stretched material. The supply of the material is increased if the depth d of the groove 50b is increased, so that the warpage occurs due to the material remaining. Consequently, the saddle warpage of the bending member can be reduced while controlling the generation of the warpage due to the material remaining by reducing the supply of the material with the reduced depth d of the groove 50b.

On the other hand, it may be possible to obtain a processing member having a further reduced variation and good flatness accuracy by reducing the depth d of the groove 50b. However, if the depth d of the groove 50b is excessively reduced, the groove 50b can not be stably formed due to the variation in quantity production, a thickness of a material, the wear of a die and the placing and displacing of the die. Accordingly, it is necessary for the depth d of the groove 50b to be 5% of the thickness or more.

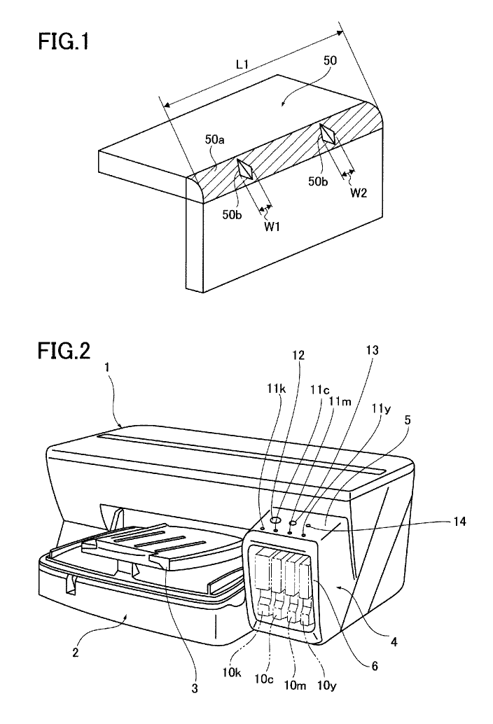

So far the warpage amount of the bending member according to the quality engineering focusing on the depth of the groove 50b has been described. Next, the relationship between the warpage amount and the opening area of the groove 50b was examined. FIG. 1 is a view describing a width of an opening portion of the groove 50b. A plurality of grooves 50b is formed in the bent portion 50a of the bending member 50 on the convex surface side of R portion (portion illustrated by diagonal line in FIG. 1). W1 and W2 in FIG. 1 are both widths of opening portions. The width indicates a widest width in the opening portion of the groove.

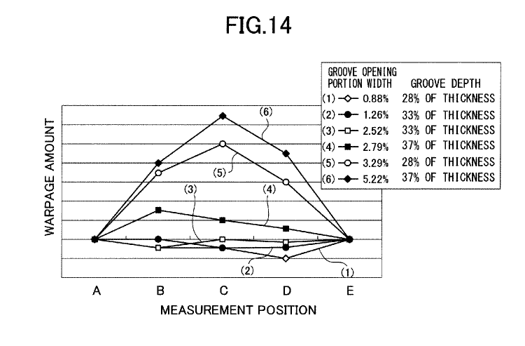

FIG. 14 provides a graph illustrating a relationship between the warpage amount and the area of the opening portion of the groove 50b.

The graph (1) shows when the ratio of the total of the widths (W1+W2 in FIG. 1) of the opening portions of the groove 50b relative to the total length (L1 in FIG. 1) of the bent portion 50a on the convex surface side s 0.88% and the depth d of the groove 50b is 28% of the thickness. The graph (2) shows when the above ratio is 1.26% and the above depth d is 33% of the thickness. The graph (3) shows when the above ratio is 2.52% and the above depth d is 33% of the thickness. The graph (4) shows when the above ratio is 2.79% and the above depth d is 37% of the thickness. The graph (5) shows when the above ratio is 3.29% and the above depth d is 28% of the thickness. The graph (6) shows when the above ratio is 5.22% and the above depth d is 37% of the thickness.

As is known from FIG. 14, when the ratio of the total of the widths of the opening portions of the groove 50b relative to the total length on the convex surface side is larger than 3%, the warpage amount is large in both cases that the depth of the groove 50b is 28% of the thickness and the depth d of the groove 50b is 37% of the thickness. On the other hand, if the ratio of the total of the widths of the opening portions of the groove 50b relative to the total length on the convex surface side is 3% or less, the warpage amount can be reduced in any of the cases that the depth d of the groove 50b is 28% of the thickness, the depth d of the groove 50b is 33% of the thickness and the depth d of the groove 50b is 37% of the thickness. This is because the appropriate amount of the material can be supplied to the stretched material in the bent portion by forming the groove 50b without being excessively supplied, so that the warpage after bending is corrected by reducing the stretching of the material.

In addition, the total values of the widths of the opening portions of the grooves 50b can be set by adjusting the width of each groove 50b or by adjusting the number of grooves 50b. However, it is preferable to adjust the width of each groove because the interval between the grooves affects the warpage as described below.

It is seen from FIG. 14 that the warpage amount can he reduced if the total ratio of the widths of the opening portions of the grooves 50b relative to the total length on the convex surface side is 3% or less, and the depth d of the groove 50b is a depth of 40% of the thickness or less. It is necessary for the depth d of the groove 50b to be 5% of the thickness or more in view of the variation in material rods in quantity production.

As described above, an effect which reduces the warpage amount can be obtained by forming along the bent portion formed by bending a plate material the grooves 50b in which the depth d is 5% of the thickness or more and 40% of the thickness or less and the total ratio of the widths of the opening portions relative to the total length of the convex surface side is 3% or less.

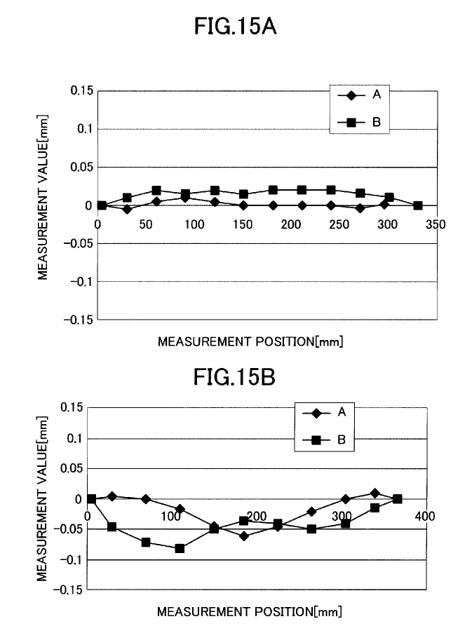

FIGS. 15A provides a graph illustrating flatness accuracy (flatness) of both surfaces sandwiching the bent portion 50a having the groove 50b formed under the most suitable condition obtained by the quality engineering. FIG. 15B provides a graph illustrating flatness accuracy (flatness) of both surfaces sandwiching the bent portion without having the groove 50b.

The legends A, B in the graphs correspond to the measurement positions A, B illustrated in FIG. 7. Regarding the measurement position A, the upper direction in FIG. 7B is positive and regarding the measurement position B, the left direction in FIG. 7B is positive. In addition, the evaluation was performed with a member for use in the after-described guide rail. A bending member of 380 mm in a length L1, 1 mm in a thickness t, and 0.1 mm in a curvature radius r was used. The groove 50b selected as the most suitable condition in which the depth d is 15% of the thickness t and the total ratio of the widths of the opening portions is 0.7% was provided in 10 positions at 40 mm intervals.

As is seen from FIG. 15B, with the constitution without having the groove 50b, the flatness accuracy of both surfaces sandwiching the bent portion is extremely deteriorated due to the warpage according to the bending (deformation to be convex in one direction) and the rolling due to the deformation by the irregular movement of the material in the surfaces according to the bending. With the conventional constitution forming the concave portion, the warpage can be reduced to some extent but an effect which reduces the rolling is small. More complex rolling occurs due to the above-described protrusion of the material from the concave portion in the bending having a small curvature radius r.

On the other hand, in the bending member in which the groove 50b is formed under the above conditions, as illustrated in FIG. 15A, both of the rolling and the warpage due to the bending can be significantly reduced, and the flatness accuracy of both surfaces sandwiching the bent portion can be significantly improved, so that the value of the flatness can be reduced to about ¼.

In order to significantly reduce the warpage and improve the flatness, it is preferable for the depth d to be the range of 10% or more and 37% or less, and it is more preferable for the depth d to be the range of 15% or more and 28% or less. On the other hand, the ratio of the widths of the opening portions contributes to the improvement in the flatness accuracy if the width is extremely small. However, it is preferable for the ratio to be the range of 0.5% or more and 1.0% or less as a more effective range.

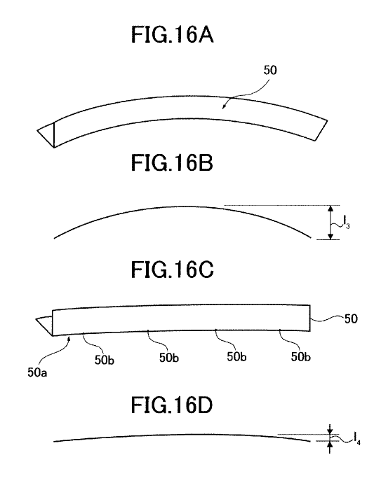

FIGS. 16A-16D are views each describing the correction of the warpage according to the embodiment of the present invention.

FIGS. 16A, 16B illustrate the bending member 50 without having the groove 50b in the bent portion 50a. FIGS. 16C, 16D illustrate the bending member 50 having in the bent portion 50a a plurality of grooves 50b formed under the most suitable condition obtained by the quality engineering.

By providing a plurality of grooves 50b in the bent portion 50a of the bending member 50, the uneven stretching of the material of the bent portion 50a is equalized. A large warpage amount l₃ in the bent portion 50a illustrated in FIGS. 16A, 16B can be corrected to be the warpage amount l₄ smaller than the warpage amount l₃ as illustrated in FIGS. 16C, 16D.

### CONSTITUTION EXAMPLE 3

### <Interval Between Grooves According to the Present Embodiment>

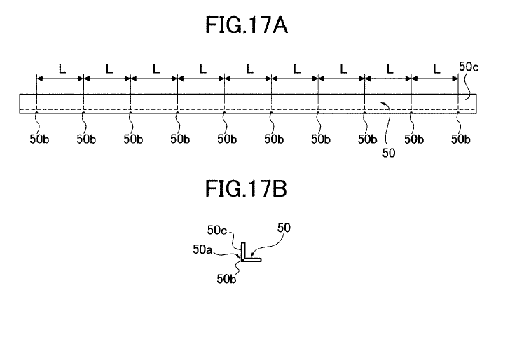

FIG. 17A is a front view of a bending member 50 describing intervals L between grooves. FIG. 17B is a side view of the bending member 50 describing the intervals L between the grooves.

A plurality of grooves 50b is formed at equal intervals L along a bent portion 50a of the bending member 50.

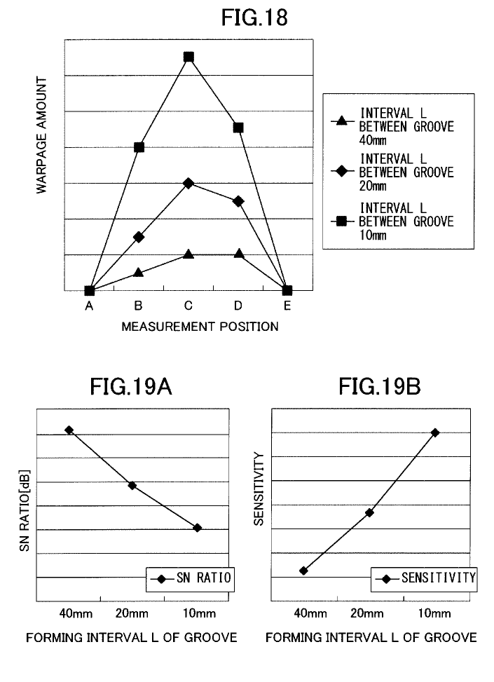

FIG. 18 provides a graph illustrating the relationship between the warpage amount and the interval between the grooves under a predetermined condition performed in the experiment. In this case, the depth d of the groove 50b is 37% of the thickness, the interval L between the grooves is 10 mm (15 grooves), 20 mm (8 grooves), and 40 mm (4 grooves). In addition, the measurement positions of the test piece where the flatness accuracy is measured are positions which are the same as the positions illustrated in FIG. 11. It is seen from FIG. 18 that the warpage amount is reduced if the interval L between the grooves is increased, and an effect which improves the flatness accuracy can be obtained.

FIG. 19A provides a factor effect graph illustrating a relationship between the interval L between the grooves and the SN ratio obtained by the experiment using the quality engineering. FIG. 19B provides a factor effect graph illustrating a relationship between the interval L between the grooves and the sensitivity obtained by the experiment using the quality experiment.

As is seen from FIG. 19A, the SN ratio is increased if the interval L between the grooves is large, and the variation is reduced. As is also seen from FIG. 19B, the sensitivity is decreased if the interval L between the grooves is large. For this reason, it was found that the bending member 50 in which the warpage amount is reduced can be manufactured by increasing the interval L between the grooves.

The recall ratio (ratio of SN ratio estimated from experiment and SN ratio obtained by the confirmation experiment) in this experiment was 82% or more. For this reason, the factor effect graphs illustrated in FIGS. 19A, 19B based on the experiment result using the quality engineering are reliable.

The decrease in the warpage amount by increasing the interval L between the grooves has the following factor. Namely, the groove 50 has an effect of supplying the material to the stretched material. However, the supply of the material is increased if the interval L between the grooves is small, so that the warpage due to the remaining material occurs. Therefore, by decreasing the supply of the material with the increased interval L between the grooves, the generation of the warpage due to the remaining material can be controlled, so that the warpage amount can be decreased.

It can be seen from the result of the experiment using the quality engineering that if the interval L between the grooves is large, the SN ratio is increased, so that the variation can be reduced, and the sensitivity can be also reduced; thus, the flatness accuracy can be improved.

### CONSTITUTION EXAMPLE 4

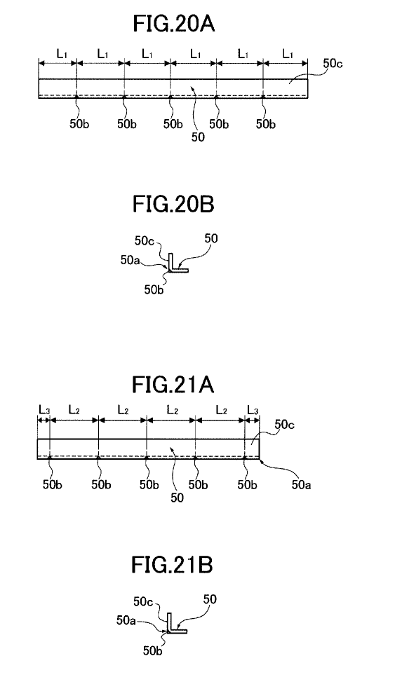

FIG. 20A is a front view illustrating a bending member 50 in which groove 50b are arranged by equally dividing the bending member 50 in the longitudinal direction. FIG. 20B is a side view illustrating the bending member 50.

The grooves 50b are arranged at equal intervals L1 on the bending line of the bent portion 50a of the bending member 50. The intervals between the grooves and the intervals from the end portions of the bending member in the longitudinal direction to the grooves 50b are set equal, so that an effect of supplying the material from the grooves 50b can be approximately equally dispersed in the longitudinal direction. Accordingly, an effect which can further improve the flatness accuracy can be obtained.

### CONSTITUTION EXAMPLE 5

FIG. 21A is a front view illustrating a bending member 50 in which the intervals between the grooves are equal in the central portion of the bending member in the longitudinal direction and the intervals from the end portions of the bending member in the longitudinal direction to the grooves 50b are different from the intervals between the grooves in the central portion of the bending member. FIG. 21B is a side view illustrating the bending member 50.

A plurality of grooves 50b is formed at equal intervals L2 on the bending line in the central portion of the bent portion 50a of the bending member 50, and the intervals L3 from the end portions of the bent portion 50a to the grooves 50b are different from the interval between the grooves in the central portion.

In FIG. 21A, the intervals from the end portions to the grooves 50b only differ from the intervals between the grooves in the central portion. However, the intervals between the grooves near the end portions can be changed, and the intervals between the grooves can be gradually changed from the central portion to the end portions in the longitudinal direction. The intervals in the end portions are set to be small in FIG. 21A; however, the interval can be changed to be increased according to the generation of warpage.

The end portions of the bending member 50 are not held. For this reason, the warpage condition differs between the central portion and the end portions if the grooves 50b are formed at equal intervals in the end portions and the central portion. Therefore, the intervals between the grooves in the end portions of the bent portion 50a and the intervals from the end portions of the bent portion 50a in the longitudinal direction to the grooves 50b are set to be different from the interval in the central portion of the bent portion 50a in accordance with the warpage condition, so that an effect which improves the flatness accuracy of the end portions of the bending member 50 can be obtained.

### CONSTITUTION EXAMPLE 6

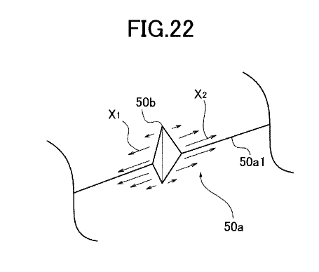

FIG. 22 is a view describing the supply of the material by a groove 50b.

The grooves 50b are formed along the bent portion 50a of the bending member 50. The material is supplied in the arrow X₁ direction or the arrow X₂ direction by the groove 50b. In this case, since the sectional shape of the groove 50b as seen from the longitudinal direction of the groove has a V-shape, the largest amount of material can be supplied on a bending line 50a1 of the bent portion 50a which has the smallest amount of material. The shortage amount of the material is decreased in the direction orthogonal to the bending line 50a1 of the bent portion 50a. However, by using the groove 50b having a V-shape in section as seen from the longitudinal direction of the groove, the supply amount of the material can be decreased in a position in the direction orthogonal to the bending line 50a1 of the bent portion, and the excess supply of the material can be controlled. Consequently, the material can be effectively supplied in accordance with the stretch of the material.

Moreover, by using the groove 50b having a V-shape in section as seen from the longitudinal direction of the groove, the projection 60e of the insert 60d provided in the die 60c can be easily processed. Accordingly, the size can be significantly reduced relative to the die, and the load to the die can be also reduced. Therefore, the bending member 50 having a highly accurate flatness can be stably mass-produced.

### CONSTITUTION EXAMPLE 7

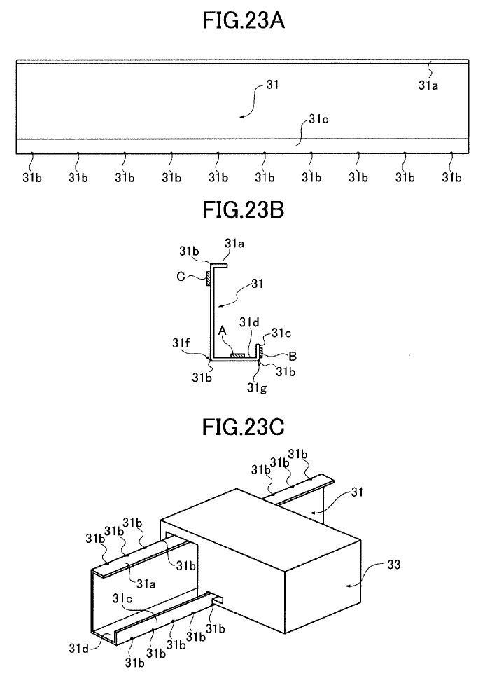

FIG. 23A is a front view illustrating a guide rail 31 of a rail member which movably supports a carriage 33. FIG. 23B is side view illustrating the guide rail 31 and FIG. 23C is a perspective view illustrating a condition in which the carriage 33 is supported to the guide rail 31.

The carriage 33 is supported by the surface of the guide rail 31. The carriage 33 slides on the surface of the guide rail 31 to perform printing. The guide rail 31 has contact with the carriage 33 with bent surfaces 31a, 31c, 31d. A plurality of fine grooves 31b is formed along bent portions 31e, 31f, 31g of the guide rail 31. In addition, a recording head 34 (refer to FIG. 3) is attached to the carriage 33.

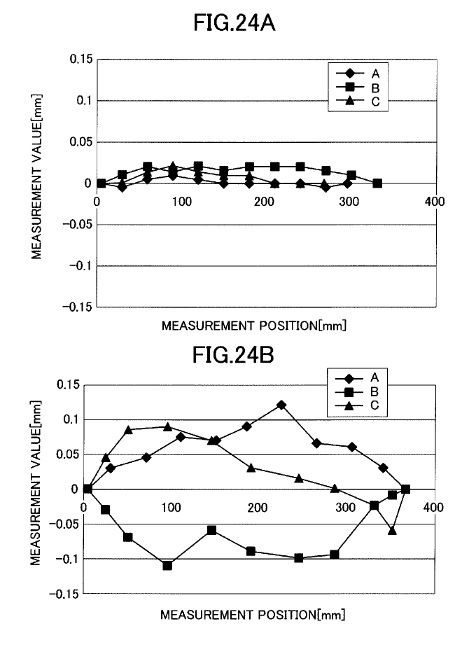

FIG. 24A provides a graph illustrating flatness accuracy of both surfaces sandwiching the bent portion with a plurality of fine grooves 31b formed along the curve of the bent portions 31e, 31f, 31g of the guide rail 31 as described above. FIG. 24B provides a graph illustrating the flatness accuracy of both surfaces sandwiching the bent portion without having the groove 31b. The legends A, B, C in the graphs correspond to the measurement positions A, B, C in FIG. 23B. Regarding the measurement position A, the upper direction in the figure is positive, regarding the measurement position B, the right direction in the figure is positive, and regarding the measurement position C, the left direction in the figure is positive. In addition, a bending member of 380 mm in a length L1, 1 mm in a thickness t, and 0.1 mm in a curvature radius r is used. The groove 31b in which the depth d is 15% of the thickness t and the ratio of the total widths of the opening portions is 0.7% is provided in 10 positions at the interval of 40 mm.

As illustrated in FIG. 24A, the flatness accuracy of each surface of the guide rail can be significantly improved by forming the grooves 31b in each bent portion 31e, 31f, 31g of the guide rail, so that the flatness can be reduced to about ⅙.

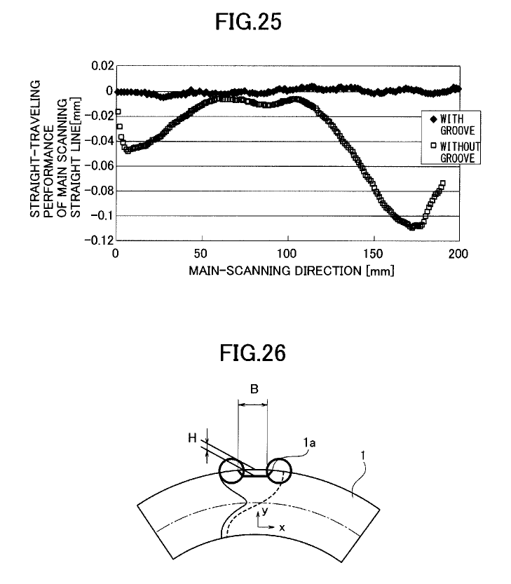

FIG. 25 illustrates a straight-traveling performance (position variation) of the carriage when moving the carriage in the main-scanning direction by using the guide rail as described above. In this case, the right direction in FIG. 23B is positive. It is seen from FIG. 25 that the flatness accuracy of the B surface of the guide rail significantly affects the straight-traveling performance of the cartridge.

As described above, with the improvement in the flatness accuracy of the guide rail 31, the liquid drops can be discharged in a predetermined position of a sheet from the recording head 34 when forming an image by moving the carriage 33 while guiding the carriage 33 with the guide rail 31. Therefore, the decrease in an image quality can be controlled.

The above description refers only to examples, and a specific effect can be obtained in each of the following embodiments.

### Embodiment A

A bending member such as a bending member 50 includes a bent portion 50a formed by bending a plate material, the bent portion 50a including a concave surface side and a convex surface side, a curvature radius r of the concave surface side of the bent portion being set to a thickness t of the plate material or below, and a plurality of grooves provided in the bent portion on the convex surface side, each of the grooves being vertical to a longitudinal direction of the bent portion, wherein each of the grooves opens on both surface sides sandwiching the bent portion, each of the grooves includes a bottom portion having a straight line shape connecting the openings of the groove on the both surface sides, a length L of the bottom portion having the straight line shape is larger than twice the curvature radius r, and a depth d of the deepest portion of each groove is smaller than the thickness t of the plate material. According to this configuration, as described above, a highly accurate flatness can be obtained on both surfaces sandwiching the bent portion of the bending member.

### Embodiment B

In Embodiment A, each of the grooves has a V-shape in section as seen from a longitudinal direction of the groove. According to this configuration, as described above, the material can be effectively supplied in accordance with the stretch of the material.

### Embodiment C

In Embodiment A or Embodiment B, the depth d of the deepest portion of the groove is 5% or more and 40% or less of the thickness, and the total of widths of opening portions of the respective grooves in a direction along the longitudinal direction of the bent portion is 3% or less of an entire length of the bent portion on the convex surface side. According to this configuration, as described above, a highly accurate flatness can be obtained.

### Embodiment D

In Embodiment A, Embodiment B, or Embodiment C, intervals between the grooves are equal. According to this configuration, as described above, an effect of supplying a material can be substantially equally dispersed in the longitudinal direction of the bent portion, so that an effect which further improves flatness accuracy can be obtained.

### Embodiment E

In Embodiment A, Embodiment B, or Embodiment C, intervals between the grooves are 40 mm or more. According to this configuration, as described above, the warpage amount can be reduced, so that an effect which further improves flatness accuracy can be obtained.

### Embodiment F

In Embodiment A, Embodiment B, or Embodiment C, intervals between the grooves are equal in a central portion of the bent portion in the longitudinal direction, and intervals between the grooves in end portions of the bent portion in the longitudinal direction differ from the intervals in the central portion of the bent portion in the longitudinal direction. According to this configuration, as described above, an effect which improves flatness accuracy of the end portions of the bent portion can be obtained.

### Embodiment G

A rail member, which movably supports a movable body while guiding the movable body includes the bending member according Embodiment A, Embodiment B, Embodiment C, Embodiment D, Embodiment E or Embodiment F. According to this configuration, as described above, the flatness accuracy of the rail member can be improved.

### Embodiment H

An image-forming apparatus includes a carriage including a head configured to discharge a liquid drop, and the rail member according to Embodiment G. According to this configuration, as described above, the flatness accuracy of the rail member can be improved, so that an image quality can be improved.

According to the embodiments of the present invention, the extrusion of the material in the directions of both surfaces sandwiching the bent portion is controlled when performing a process, which controls saddle warpage, to the bent portion. Therefore, both surfaces having highly accurate flatness sandwiching the bent portion can be formed.

According to the embodiments of the present invention, an effect which can obtain highly accurate flatness on both surfaces sandwiching the bent portion of the bending member can be obtained. Although the embodiments of the present invention have been described above, the present invention is not limited thereto. It should be appreciated that variations may be made in the embodiments described by persons skilled in the art without departing from the scope of the present invention.

What is claimed is:

1. A bending member, comprising:
a bent portion formed by bending a plate material, the bent portion including a concave surface side and a convex surface side, a curvature radius r of the concave surface side of the bent portion being set to a thickness t of the plate material or below; and
a plurality of grooves provided in the bent portion on the convex surface side, each of the grooves being vertical to a longitudinal direction of the bent portion, wherein
each of the grooves opens on both surface sides sandwiching the bent portion,
each of the grooves includes a bottom portion having a straight line shape connecting the openings of the groove on both surface sides,
a length L of the bottom portion having the straight line shape is larger than twice the curvature radius r, and
a depth d of the deepest portion of each groove is smaller than the thickness t of the plate material.

2. The bending member according to claim 1, wherein each of the grooves has a V-shape in section as seen from a longitudinal direction of the groove.

3. The bending member according to claim 1, wherein
the depth d of the deepest portion of the groove is 5% or more and 40% or less of the thickness, and
the total of widths of opening portions of the respective grooves in a direction along the longitudinal direction of the bent portion is 3% or less of an entire length of the bent portion on the convex surface side.

4. The bending member according to claim 1, wherein intervals between the grooves are equal.

5. The bending member according to claim 1, wherein intervals between the grooves are 40 mm or more.

6. The bending member according to Claim I, wherein
intervals between the grooves are equal in a central portion of the bent portion in the longitudinal direction, and
intervals between the grooves in end portions of the bent portion in the longitudinal direction differ from the intervals in the central portion of the bent portion in the longitudinal direction.

7. A rail member, which movably supports a movable body while guiding the movable body, comprising the bending member according to claim 1.

8. An image-forming apparatus, comprising:
a carriage including a head configured to discharge a liquid drop; and
the rail member according to claim 7.
